(19) United States
(12) Patent Application Publication
(10) Pub. No.: US 2010/0103905 A1
(43) Pub. Date: Apr. 29, 2010

(54) METHOD AND SYSTEM FOR SERVICE LINK HANDOVER

(75) Inventor: Shengqiang Yang, Shenzhen (CN)

Correspondence Address: Huawei Technologies Co., Ltd.;c/o Darby & Darby P.C., P.O. Box 770, Church Street Station, New York, NY, 10008-0770, US

(73) Assignee: HUAWEI TECHNOLOGIES CO., LTD., Shenzhen (CN)

(21) Appl. No.: 12/650,055

(22) Filed: Dec. 30, 2009

Related U.S. Application Data
(63) Continuation of application No. PCT/CN2008/071962, filed on Aug. 12, 2008.

(30) Foreign Application Priority Data
Aug. 15, 2007 (CN) 200710138095.3

(51) Int. Cl. H04W 36/00

(52) U.S. Cl. 370/331

(57) ABSTRACT

A method and a system for service link handover are provided. The method and the system are in a communication technical field. The method is as follows. Apply for service processing resources of a second service processing unit. A service link establishment message is sent to the second service processing unit, in which the message carries link address information of a first service node and a second service node, such that the second service processing unit binds link addresses of the first service node and the second service node. A response message from the second service processing unit is received, and a link handover indication message is sent to the first service node and the second service node, such that the first service node and the second service node hand over link connections to the second service processing unit. Thus, an efficiency of a rolling upgrade is improved and a service interruption possibly caused by the rolling upgrade is avoided when units in the same resource pool perform the rolling upgrade.

### CROSS-REFERENCE TO RELATED APPLICATIONS

This is a continuation of International Application No. PCT/CN2008/071962, filed on Aug. 12, 2008, which claims priority to Chinese Patent Application No. 200710138095.3, filed on Aug. 15, 2007, both of which are hereby incorporated by reference in their entireties.

### FIELD OF THE INVENTION

The present invention relates to a communication technical field, and more particularly to a method and a system for service link handover.

### BACKGROUND OF THE INVENTION

As telecommunication technology is quickly developed, in many telecommunication systems, in order to expand functions and add services, the telecommunication systems or telecommunication equipment need to be continuously upgraded. In addition, problems may be generated during a running process of the telecommunication equipment, so the equipment needs to be upgraded and replaced to solve the problems. However, the telecommunication equipment has higher requirements for reliability. The common telecommunication equipment requires a reliability of 99.999%, that is, only approximately an interruption of 5 minutes is allowed per year. Therefore, it is an issue that draws the attention of manufacturers of telecommunication equipment and operators to reduce the time of the service interruption when the equipment is upgraded or is faulty.

The prior art one provides a common method for improving the reliability by configuring a resource pool of service plane boards. For example, when the service plane boards are in upgrading procedure, the service boards are smoothly upgraded to a new version through a rolling upgrade mechanism, so as to ensure that the services of the entire system are not interrupted during upgrading. Specifically, the service boards of the entire resource pool are divided into at least two batches, and each batch includes at least one board. Then, a board isolating command is executed in the background in sequence, such that each batch of the boards is isolated, and new calls will not be connected to the isolated boards. When all the existing calls of the isolated boards are released, the boards are reset, the new version is loaded, and the boards are restarted. After one batch is already upgraded, the isolation is released, and then the next batch is isolated for upgrade. Through the rolling upgrade, it is ensured that the services are not interrupted during the upgrade.

The prior art one has the following problem: In the current rolling upgrade process, the new version is loaded only after all the existing calls of the isolated boards are released, but the durations of the existing calls are uncertain; the durations of the calls may be quite long, such that it takes quite a long time to complete the whole upgrade, and the upgrade process cannot be controlled.

The prior art two provides a common method for improving the reliability by configuring a resource pool of service plane boards. For example, the service boards of the entire resource pool are divided into at least two batches, and each batch includes at least one board. Then, a board isolating command is executed in the background in sequence, such that each batch of the boards is isolated, and new calls will not be connected to the isolated boards. The process waits for a period of time after the boards are isolated, and then regardless of whether the calls are in progress, the process forcedly enters the next stage, in which the isolated boards are forced to reset, and the new version is loaded. After one batch is already upgraded, the isolation is released, and then the next batch is isolated for upgrade.

The prior art two has the following problem. The board on which call services are on progress may be forced to reset, so some calls may be dropped, resulting in the service interruption.

### SUMMARY OF THE INVENTION

Accordingly, the embodiments of the present invention are directed to a method and a system for service link handover, which improve an efficiency of a rolling upgrade and avoid a service interruption possibly caused by the rolling upgrade when service units in a resource pool perform the rolling upgrade.

An embodiment of the present invention provides a method for service link handover, which includes the following steps:

Apply for a service processing resource of a second service processing unit.

A service link establishment message is sent to the second service processing unit, in which the message carries link address information of a first service node and a second service node, such that the second service processing unit binds link addresses of the first service node and the second service node.

A response message from the second service processing unit is received, and a link handover indication message is sent to the first service node and the second service node, such that the first service node and the second service node hand over link connections to the second service processing unit.

Another embodiment of the present invention further provides a method for a service link handover, which includes the following steps.

A service link establishment message is received, in which the message carries link address information of a first service node and a second service node.

Link addresses of the first service node and the second service node are bound.

A link handover indication message is sent to the first service node and the second service node, such that the first service node and the second service node hand over link connections to a unit binding the link addresses of the first service node and the second service node.

Another embodiment of the present invention further provides a method for service link handover, which includes the following steps.

A service link establishment message is sent, in which the message carries link address information of a first service node and a second service node, such that a second service processing unit allocates service processing resources thereof, and binds link addresses of the first service node and the second service node.

A response message from the second service processing unit is received, and a link handover indication message is sent to the first service node and the second service node, such that the first service node and the second service node hand over link connections to the second service processing unit.

Another embodiment of the present invention further provides a method for service link handover, which includes the following steps.

A service link establishment message is received, in which the message carries link address information of a first service node and a second service node.

Service processing resources are allocated, and link addresses of the first service node and the second service node are bound.

A link handover indication message is sent to the first service node and the second service node, such that the first service node and the second service node hand over link connections to a unit binding the link addresses of the first service node and the second service node.

In another aspect, an embodiment of the present invention provides a system for service link handover. The system is as follows:

An embodiment of the present invention further provides a system for a service link handover. The system includes a control unit, a second service processing unit, a first service node, and a second service node.

The control unit is adapted to apply for service processing resources of the second service processing unit, and send a link establishment message to the second service processing unit, in which the message carries address information of the first service node and the second service node.

The second service processing unit is adapted to receive the link establishment message, and bind link addresses of the first service node and the second service node according to the address information.

The first service node and the second service node are adapted to hand over link connections to the second service processing unit when receiving a link handover indication message.

Another embodiment of the present invention further provides a system for service link handover. The system includes a first control unit, a second service processing and control unit, a first service node, and a second service node.

The first control unit is adapted to send a link establishment message to the second service processing and control unit, in which the message carries address information of the first service node and the second service node.

The second service processing and control unit is adapted to receive the link establishment message, allocate idle service processing resources, and establish links with the first service node and the second service node according to the address information.

The first service node and the second service node are adapted to hand over link connections to the second service processing and control unit when receiving a link handover indication message.

It may be known from the embodiments of the present invention that when a first service processing unit is updated, the link establishment message is sent to the second service processing unit, the second service processing unit establishes the links with the first service node and the second service node. The first service node and the second service node hand over the link connections with the first service processing unit to the second service processing unit. Therefore, a service path of the first service processing unit is transferred to the second service processing unit, such that when the first service processing unit is reset and upgraded, the time cost in waiting and the service interruption are avoided, and the efficiency of the upgrade is improved.

### BRIEF DESCRIPTION OF THE DRAWINGS

FIG. 1 is a schematic view of a network structure according to a first embodiment of the present invention;

FIG. 2 is a flow chart of a first example according to the first embodiment of the present invention;

FIG. 3 is a flow chart of a second example according to the first embodiment of the present invention;

FIG. 4 is a schematic view of a network structure according to a second embodiment of the present invention;

FIG. 5 is a flow chart of a first example according to the second embodiment of the present invention;

FIG. 6 is a flow chart of a second example according to the second embodiment of the present invention;

FIG. 7 is a schematic view of a network structure according to a third embodiment of the present invention;

FIG. 8 is a flow chart of a first example according to the third embodiment of the present invention;

FIG. 9 is a flow chart of a second example according to the third embodiment of the present invention;

FIG. 10 is a schematic view of a system according to the first embodiment of the present invention; and

FIG. 11 is a schematic view of a system according to the second embodiment and the third embodiment of the present invention.

### DETAILED DESCRIPTION OF THE EMBODIMENTS

Embodiments of the present invention provide a method and a system for service link handover, which improve an efficiency of a rolling upgrade and avoid a service interruption possibly caused by the rolling upgrade when units in a resource pool perform the rolling upgrade. To make the technical solutions of the present invention clearer and more understandable, the present invention is described in detail in the following with reference to the embodiments and the accompanying drawings.

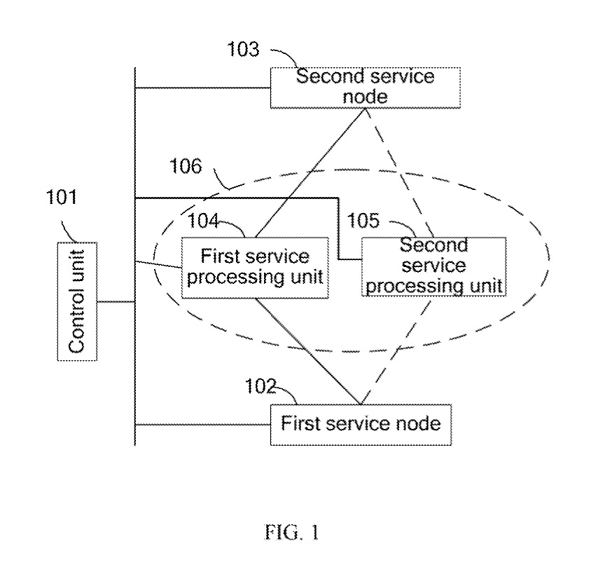

FIG. 1 is a schematic view of a network structure according to a first embodiment of the present invention.

Referring to FIG. 1, a first service processing unit 104 and a second service processing unit 105 are in a same service processing resource pool 106. The first service processing unit 104 is an isolated unit to be updated, and the second service processing unit 105 and the first service processing unit 104 are divided into two different batches in a rolling upgrade of the resource pool, such that when the first service processing unit 104 is being upgraded, the second service processing unit 105 normally runs instead of being upgraded at the same time.

The control unit 101 is responsible for signaling control, and the control unit 101 controls service processing resources and connection and releasing of service links of the first service processing unit 104 and the second service processing unit 105. The control unit 101 performs a signaling exchange with other equipment through a signaling channel.

The first service processing unit 104 has a call service when being isolated, and a processing path of the call service is a first service node 102⇄the first service processing unit 104⇄a second service node 103. The call is transferred from the first service processing unit 104 to the second service processing unit 105, and the processing path of the call service is changed to the first service node 102⇄the second service processing unit 105⇄the second service node 103. After all the services of the first service processing unit 104 are already transferred, the first service processing unit 104 is reset and upgraded to a new version without service loss.

Several examples are given in the following to describe the first embodiment of the present invention.

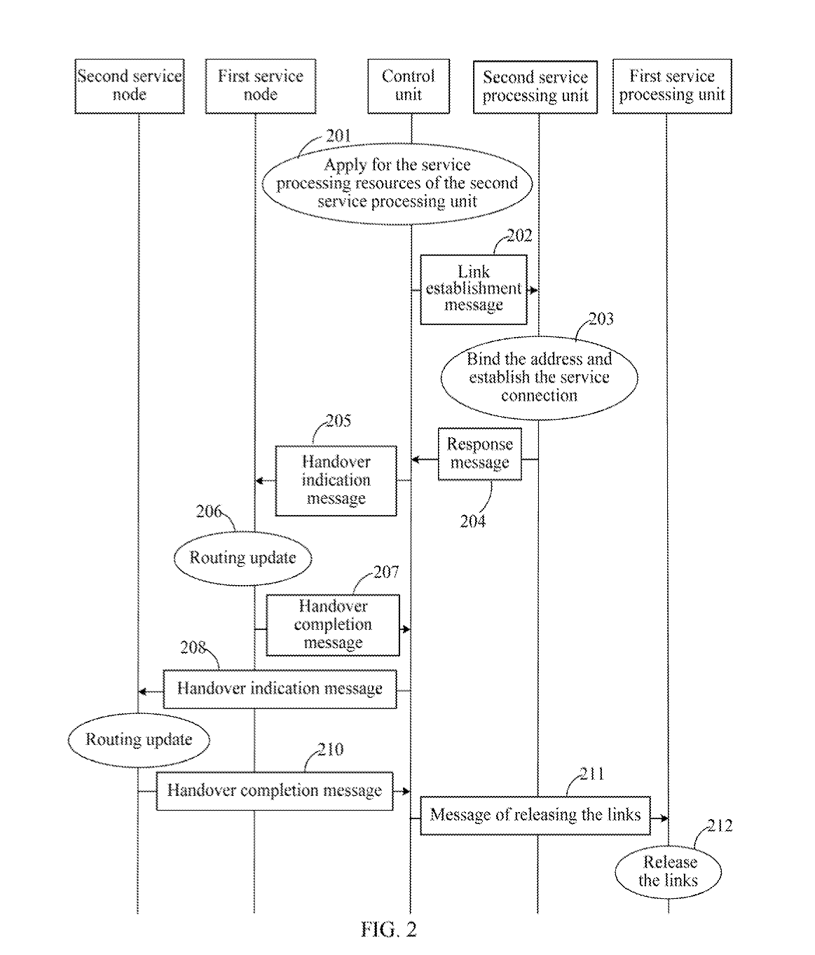

FIG. 2 is a flow chart of a first example according to the first embodiment of the present invention.

In Step 201, the control unit applies for service processing resources of the second service processing unit.

In Step 202, the control unit sends a service link establishment message to the second service processing unit, in which the message includes the service processing resources of the second service processing unit, and link address information of the first service node and the second service node in an original call service link.

In Step 203, the second service processing unit binds link addresses of the first service node and the second service node and establishes the service link.

In Step 204, the second service processing unit returns a response message to the control unit.

In Step 205, after receiving the response message from the second service processing unit, the control unit sends a link handover indication message to the first service node.

In Step 206, the first service node performs a routing update, so as to hand over a link connection with the first service processing unit to the second service processing unit.

In Step 207, after completing the link handover, the first service node sends a link handover completion message to the control unit.

In Step 208, the control unit sends the link handover indication message to the second service node.

In Step 209, the second service node performs the routing update, so as to hand over a link connection with the first service processing unit to the second service processing unit.

In Step 210, after completing the link handover, the second service node sends a link handover completion message to the control unit.

The first example of the embodiment may further include the following steps.

In Step 211, the control unit sends a message of releasing the link connections with the first service node and the second service node to the first service processing unit.

In Step 212, the first service processing unit releases the connections with the first service node and the second service node.

In this embodiment, firstly Steps 205 to 207 are executed, and then Steps 208 to 210 are executed. In actual applications, Steps 208 to 210 may be firstly executed, and then Steps 205 to 207 are executed, or Steps 205 to 207 and Steps 208 to 210 are processed at the same time.

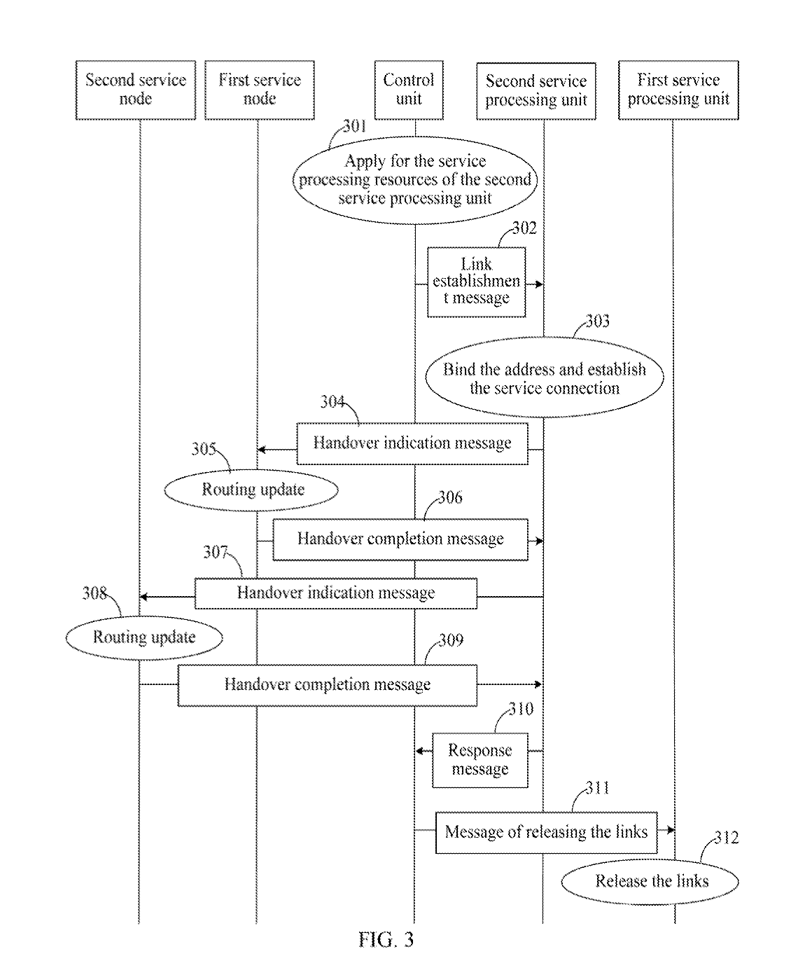

FIG. 3 is a flow chart of a second example according to the first embodiment of the present invention.

In Step 301, the control unit applies for the service processing resources of the second service processing unit.

In Step 302, the control unit sends the service link establishment message to the second service processing unit, in which the message carries the service processing resources of the second service processing unit, and link address information of the first service node and the second service node in the original call service link.

In Step 303, the second service processing unit binds the link addresses of the first service node and the second service node and establishes the service link.

In Step 304, the second service processing unit sends the link handover indication message to the first service node.

In Step 305, the first service node performs the routing update, so as to hand over the link connection with the first service processing unit to the second service processing unit.

In Step 306, after completing the link handover, the first service node sends the link handover completion message to the second service processing unit.

In Step 307, the second service processing unit sends the link handover indication message to the second service node.

In Step 308, the second service node performs the routing update, so as to hand over the link connection with the first service processing unit to the second service processing unit.

In Step 309, after completing the link handover, the second service node sends the link handover completion message to the second service processing unit.

In Step 310, the second service processing unit returns the response message to the control unit.

This embodiment may further include the following steps.

In Step 311, the control unit sends the message of releasing the link connections with the first service node and the second service node to the first service processing unit.

In Step 312, the first service processing unit releases the connections with the first service node and the second service node.

In this embodiment, firstly Steps 304 to 306 are executed, and then Steps 307 to 309 are executed. In actual applications, Steps 307 to 309 may be firstly executed, and then Steps 304 to 306 are executed, or Steps 304 to 306 and Steps 307 to 309 are processed at the same time.

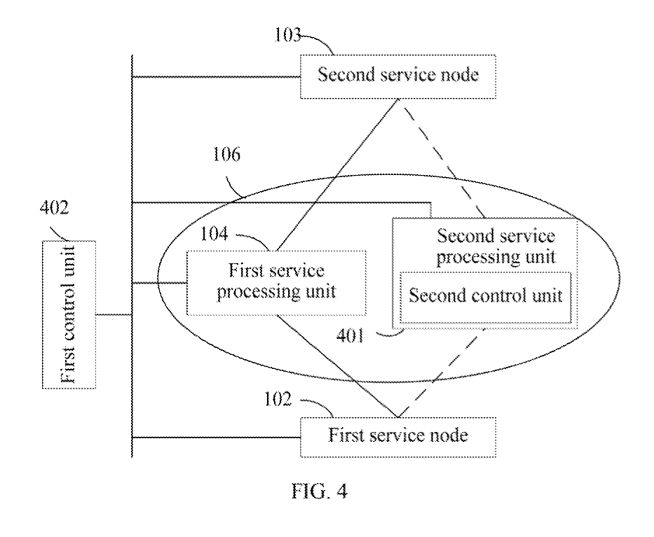

FIG. 4 is a schematic view of a network structure according to a second embodiment of the present invention.

Referring to FIG. 4, a first service processing unit 104 and a second service processing and control unit 401 are in a same service processing resource pool 106. The first service processing unit 104 is an isolated unit to be updated, and the second service processing and control unit 401 may control service processing resources, and connection and releasing of service links. The second service processing and control unit 401 and the first service processing unit 104 are divided into two different batches in a rolling upgrade of the resource pool, such that when the first service processing unit 104 is upgraded, the second service processing and control unit 401 normally runs instead of being upgraded at the same time.

A first control unit 402 is responsible for signaling control, and controls the service processing resources, the connection and releasing of the service links of the first service processing unit 104, and the first control unit 402 performs a signaling exchange with other equipment through a signaling channel.

The first service processing unit 104 has a call service when being isolated, and a processing path of the call service is a first service node 102⇄the first service processing unit 104⇄a second service node 103. The call is transferred from the first service processing unit 104 to the second service processing and control unit 401, and the processing path of the call service is changed to the first service node 102⇄the second service processing and control unit 401⇄the second service node 103. After all the services of the first service processing unit 104 are already transferred, the first service processing unit 104 is reset and upgraded to a new version without service loss.

Several examples are given in the following to describe the second embodiment of the present invention.

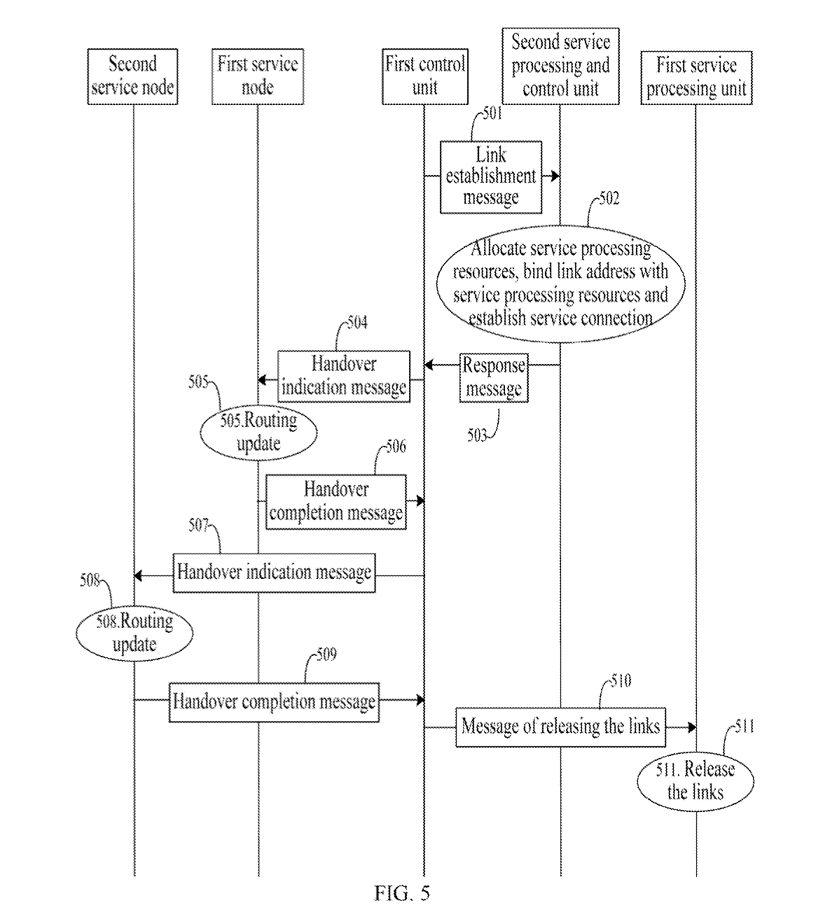

FIG. 5 is a flow chart of a first example according to the second embodiment of the present invention.

In Step 501, the first control unit sends a service link establishment message to the second service processing and control unit, in which the message includes link address information of the first service node and the second service node in an original call service link.

In Step 502, the second service processing and control unit allocates service processing resources thereof, and binds link addresses of the first service node and the second service node and establishes the service link.

In Step 503, the second service processing and control unit returns a response message to the first control unit.

In Step 504, after receiving the response message from the second service processing and control unit, the first control unit sends a link handover indication message to the first service node.

In Step 505, the first service node performs a routing update, so as to hand over a link connection with the first service processing unit to the second service processing and control unit.

In Step 506, after completing the link handover, the first service node sends a link handover completion message to the first control unit.

In Step 507, the first control unit sends the link handover indication message to the second service node.

In Step 508, the second service node performs the routing update, so as to hand over a link connection with the first service processing unit to the second service processing and control unit.

In Step 509, after completing the link handover, the second service node sends a link handover completion message to the control unit.

The first example of the second embodiment may further include the following steps.

In Step 510, the first control unit sends a message of releasing the link connections with the first service node and the second service node to the first service processing unit.

In Step 511, the first service processing unit releases the connections with the first service node and the second service node.

In this embodiment, firstly Steps 504 to 506 are executed, and then Steps 507 to 509 are executed. In actual applications, Steps 507 to 509 may be firstly executed, and then Steps 504 to 506 are executed, or Steps 504 to 506 and Steps 507 to 509 are processed at the same time.

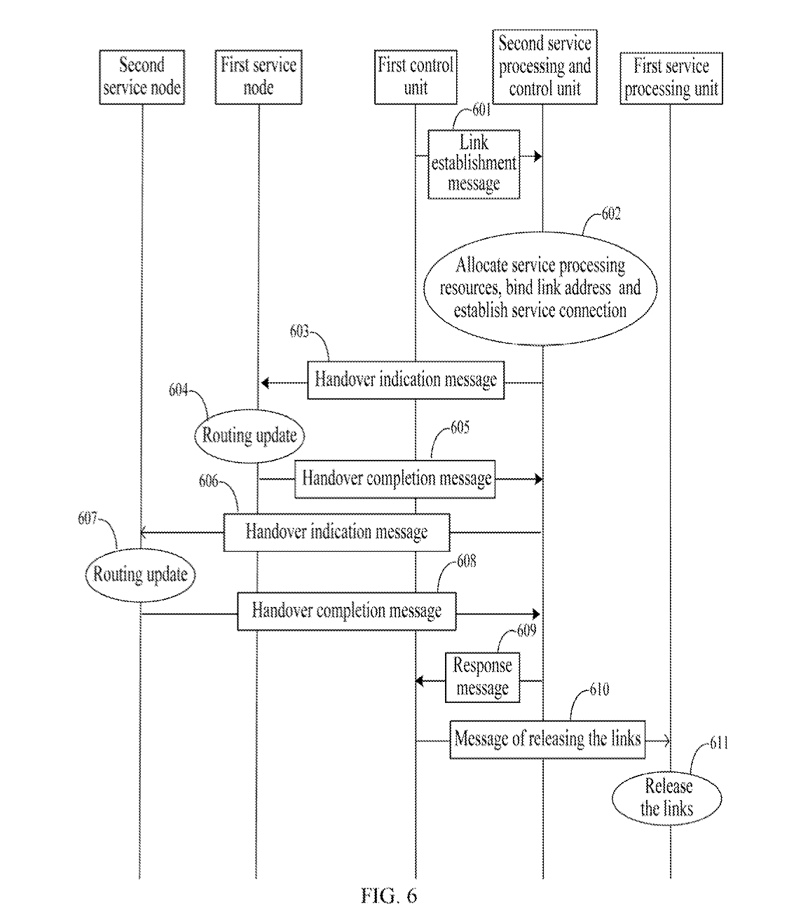

FIG. 6 is a flow chart of a second example according to the second embodiment of the present invention.

In Step 601, the first control unit sends the service link establishment message to the second service processing and control unit, in which the message includes link address information of the first service node and the second service node in the original call service link.

In Step 602, the second service processing and control unit allocates service processing resources thereof, and binds the link addresses of the first service node and the second service node and establishes the service link.

In Step 603, after establishing the service link with the first node and the second service node, the second service processing and control unit sends the link handover indication message to the first service node.

In Step 604, the first service node performs the routing update, so as to hand over the link connection with the first service processing unit to the second service processing and control unit.

In Step 605, after completing the link handover, the first service node sends the link handover completion message to the second service processing and control unit.

In Step 606, the second service processing and control unit sends the link handover indication message to the second service node.

In Step 607, the second service node performs the routing update, so as to hand over the link connection with the first service processing unit to the second service processing and control unit.

In Step 608, after completing the link handover, the second service node sends the link handover completion message to the second service processing and control unit.

In Step 609, the second service processing and control unit returns the response message to the control unit.

The second example of the embodiment may further include the following steps.

In Step 610, the first control unit sends the message of releasing the link connections with the first service node and the second service node to the first service processing unit.

In Step 611, the first service processing unit releases the connections with the first service node and the second service node.

In this embodiment, firstly Steps 603 to 605 are executed, and then Steps 606 to 608 are executed. In actual applications, Steps 606 to 608 may be firstly executed, and then Steps 603 to 605 are executed, or Steps 603 to 605 and Steps 606 to 608 are processed at the same time.

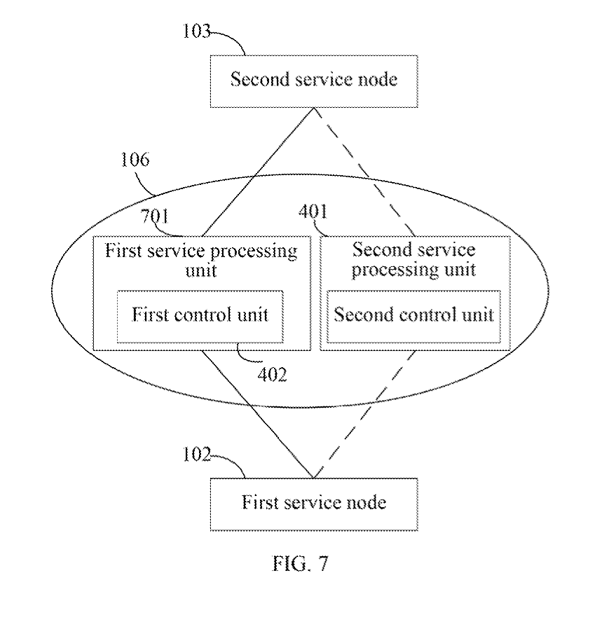

FIG. 7 is a schematic view of a network structure according to a third embodiment of the present invention.

A first service processing and control unit 701 and a second service processing and control unit 401 are in a same service processing resource pool 106. The first service processing and control unit 701 is an isolated unit to be updated, and the first service processing and control unit 701 and the second service processing and control unit 401 can control service processing resources, and connection and releasing of service links. The second service processing and control unit 401 and the first service processing and control unit 701 are divided into two different batches in a rolling upgrade of the resource pool, such that when the first service processing and control unit 701 is upgraded, the second service processing and control unit 401 normally runs instead of being upgraded at the same time.

A first control unit 402 is responsible for signaling control, and controls the service processing resources, the connection and releasing of the service links of the first service processing and control unit 701, and the first control unit 402 performs signaling exchange with other equipment through a signaling channel.

The first service processing and control unit 701 has a call service when being isolated, and a processing path of the call service is a first service node 102⇄the first service processing and control unit 701⇄a second service node 103. The call is transferred from the first service processing and control unit 701 to the second service processing and control unit 401, and the processing path of the call service is changed to the first service node 102⇄the second service processing and control unit 401⇄the second service node 103. After all the services of the first service processing and control unit 701 are already transferred, the first service processing and control unit 701 is reset and upgraded to a new version without service loss.

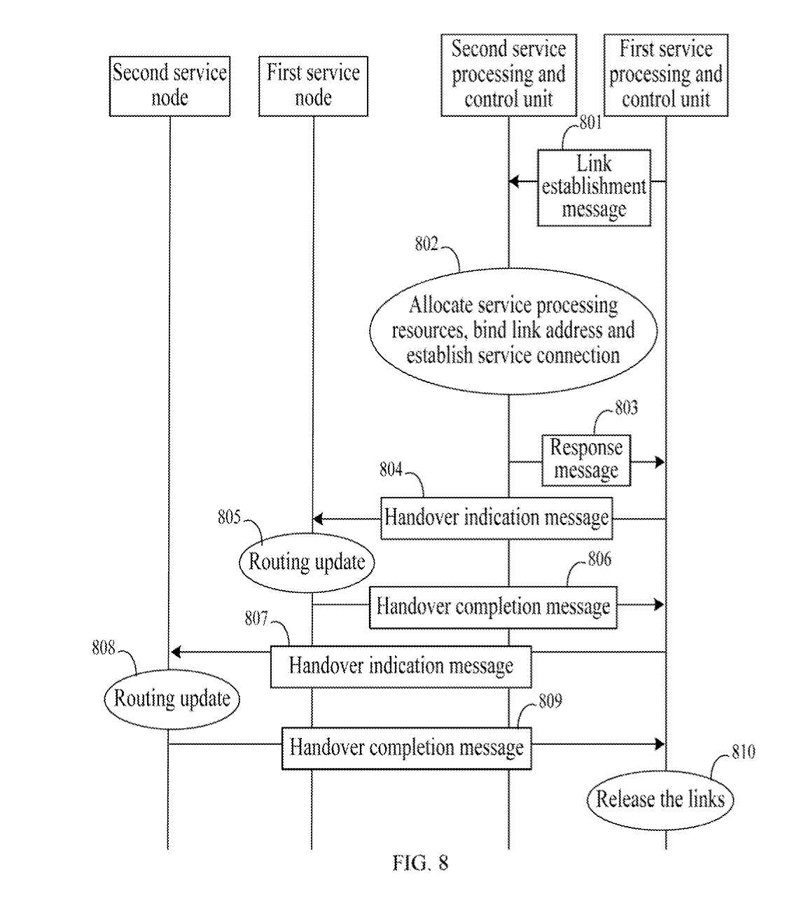

FIG. 8 is a flow chart of a first example according to the third embodiment of the present invention, which includes the following steps.

In Step 801, the first service processing and control unit sends a link connection establishment message to the second service processing and control unit, in which the message includes link address information of the first service node and the second service node in an original call service link.

In Step 802, the second service processing and control unit allocates service processing resources thereof, and binds link addresses of the first service node and the second service node and establishes the service connection.

In Step 803, the second service processing and control unit returns a response message to the first service processing and control unit.

In Step 804, after receiving the response message from the second service processing and control unit, the first service processing and control unit sends a link handover indication message to the first service node.

In Step 805, the first service node performs a routing update, so as to hand over a link connection with the first service processing and control unit to the second service processing and control unit.

In Step 806, after completing the link handover, the first service node sends a link handover completion message to the first processing and control unit.

In Step 807, the first service processing and control unit sends the link handover indication message to the second service node.

In Step 808, the second service node performs the routing update, so as to hand over a link connection with the first service processing and control unit to the second service processing and control unit.

In Step 809, after completing the link handover, the second service node sends a link handover completion message to the first service processing and control unit.

The first example of this embodiment may further include the following steps.

In Step 810, the first service processing and control unit releases the link connections with the first service node and the second service node.

In this embodiment, firstly Steps 804 to 806 are executed, and then Steps 807 to 809 are executed. In actual applications, Steps 807 to 809 may be firstly executed, and then Steps 804 to 806 are executed, or Steps 804 to 806 and Steps 807 to 809 are processed at the same time.

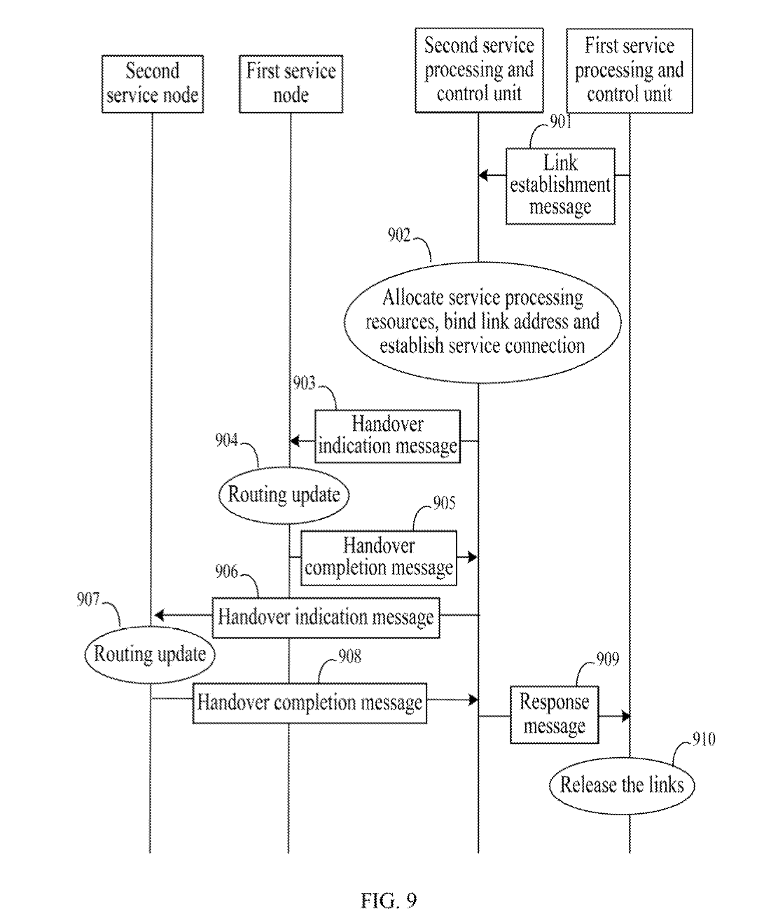

FIG. 9 is a signaling flow chart of a second example according to the third embodiment of the present invention.

In Step 901, the first service processing and control unit sends the link connection establishment message to the second service processing and control unit, in which the message includes link address information of the first service node and the second service node in an original call service link.

In Step 902, the second service processing and control unit allocates service processing resources thereof, binds the link addresses of the first service node and the second service node in the original call link, and establishes the service connections with the first service node and the second service node.

In Step 903, the second service processing and control unit sends the link handover indication message to the first service node.

In Step 904, the first service node performs the routing update, so as to hand over the link connection with the first service processing and control unit to the second service processing and control unit.

In Step 905, after completing the link handover, the first service node sends the link handover completion message to the second service processing and control unit.

In Step 906, the second service processing and control unit sends the link handover indication message to the second service node.

In Step 907, the second service node performs the routing update, so as to hand over the link connection with the first service processing and control unit to the second service processing and control unit.

In Step 908, after completing the link handover, the second service node sends the link handover completion message to the second service processing and control unit.

The second example of this embodiment may further include the following steps.

In Step 909, the second service processing and control unit sends the response message to the first service processing and control unit.

In Step 910, the first service processing and control unit releases the connections with the first service node and the second service node.

In this embodiment, firstly Steps 903 to 905 are executed, and then Steps 906 to 908 are executed. In actual applications, Steps 906 to 908 may be firstly executed, and then Steps 903 to Step 905 are executed, or Steps 903 to 905 and Steps 906 to 908 are processed at the same time.

The method according to the embodiments of the present invention is described in detail in the above. Then, the system according to the embodiment of the present invention will be described as follows.

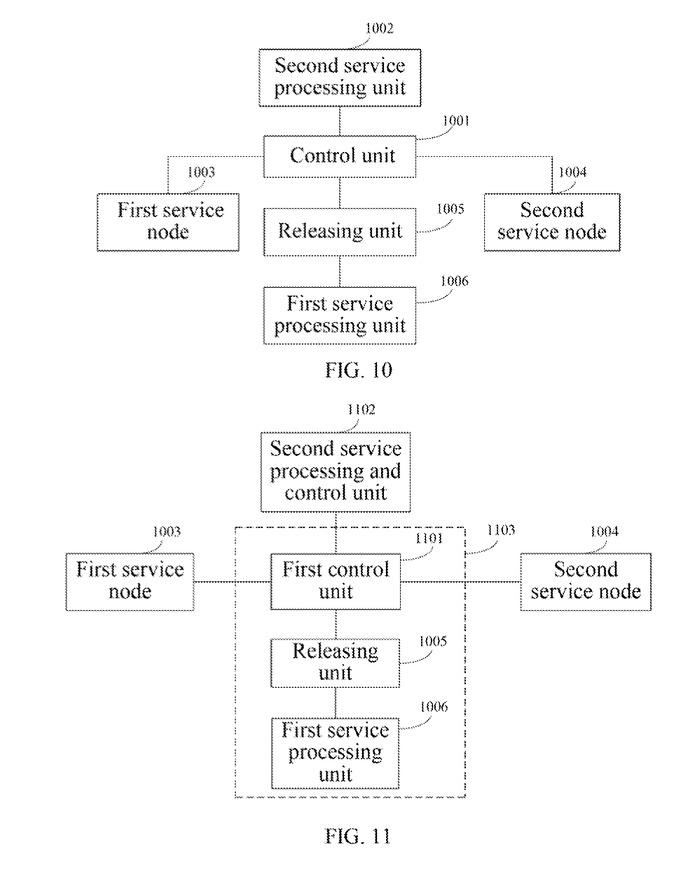

Referring to FIG. 10, it is a schematic view of a system according to the first embodiment of the present invention. The system includes a control unit 1001, a second service processing unit 1002, a first service node 1003, and a second service node 1004.

The control unit 1001 is adapted to apply for service processing resources of the second service processing unit 1002, and send a link establishment message to the second service processing unit 1002, in which the message carries address information of the first service node 1003 and the second service node 1004.

The control unit 1001 manages the service processing resources of the second service processing unit 1002.

The second service processing unit 1002 is adapted to allocate service processing resource in response to the received application, receive the link establishment message, and bind the address of the first service node 1003 and the second service node 1004 and establish links with the first service node 1003 and the second service node 1004 according to the address information.

The first service node 1003 and the second service node 1004 are adapted to hand over the link connections to the second service processing unit 1002 when receiving a link handover indication message.

The system according to this embodiment further includes a releasing unit 1005 and a first service processing unit 1006.

The releasing unit 1005 is adapted to send a message of releasing the link connections when knowing that the first service node 1003 and the second service node 1004 complete the link handover.

The first service processing unit 1006 is adapted to release the links with the first service node 1003 and the second service node 1004 when receiving the message of releasing the link connections from the releasing unit 1005.

FIG. 11 is a schematic view of a system according to the second embodiment and the third embodiment of the present invention. The system includes a first control unit 1101, a second service processing and control unit 1102, a first service node 1003, and a second service node 1004.

The first control unit 1001 is adapted to send a link establishment message to the second service processing unit 1102, in which the message carries address information of the first service node 1003 and the second service node 1004.

The second service processing and control unit 1102 is formed by a second service processing unit and a second control unit, and manages service resources of the second service processing unit.

The second service processing and control unit 1102 is adapted to receive the link establishment message, allocate idle service processing resources, and establish links with the first service node 1003 and the second service node 1004 according to the address information.

The first service node 1003 and the second service node 1004 are adapted to hand over the link connections with a first service processing unit to the second service processing and control unit 1102 when receiving a link handover indication message.

The system according to the embodiment further includes a releasing unit 1005 and a first service processing unit 1006.

The releasing unit 1005 is adapted to send a release link message when the first service node 1003 and the second service node 1004 complete the link handover.

The first service processing unit 1006 is adapted to release the links with the first service node 1003 and the second service node 1004 when receiving the release link message of releasing the link connections from the releasing unit 1005.

The first service processing unit 1006, the first control unit 1101, and the releasing unit 1005 may be integrated into a first service processing and control unit 1103. When receiving the response message from the second service processing and control unit 1102 or receiving the link handover completion messages from the first service node 1003 and the second service node 1004, the first service processing and control unit 1103 releases the link connections with the first service node 1003 and the second service node 1004.

It may be known from the embodiments that when the first service processing unit is updated, the link establishment message is sent to the second service processing unit, and the second service processing unit establishes the links with the first service node and the second service node. The first service node and the second service node hand over the link connections with the first service processing unit to the second service processing unit. Therefore, the service path of the first service processing unit is transferred to the second service processing unit, thereby avoiding the service interruption. Further, when the first service processing unit is reset and upgraded, it is unnecessary to perform the upgrade after the services of the first service processing unit are completely processed, so the efficiency of the upgrade is improved.

It is understood by those of ordinary skill in the art that all or a part of the steps of the method according to the embodiments may be implemented through relevant hardware instructed by programs, in which the programs may be stored in a computer readable storage medium.

The storage medium may be a read only memory (ROM), a magnetic disk, or an optical disk.

The method and the system for service link handover according to the present invention are described in detail. It will be apparent to those of ordinary skill in the art that various modifications and variations can be made to the specific implementations and application scope of the present invention on the basis of the spirit of the embodiments of the present invention. Therefore, the specification shall not be construed as any limit to the present invention.

What is claimed is:

1. A method for service link handover comprising:
sending a service link establishment message which carries link address information of a first service node and a second service node to a second service processing unit; wherein the second service processing unit allocates a service processing resource and binds the link address of the first service node and the second service node and establishes the service link; and
sending a link handover indication message which instructs the first service node and the second service node to hand over link connections with a first service processing unit to the second service processing unit.

2. The method of claim 1, wherein the method further comprises:
receiving link handover completion message from the first service node and the second service node; and
sending a release link message to instruct the first service processing unit to release link connections with the first service node and the second service node in response to the release link message.

3. The method of claim 1, wherein the method further comprises:
receiving a response message from the second service processing unit before sending the link handover indication message to the second service processing unit.

4. A method for service link handover, comprising:
receiving a service link establishment message which carries link address information of a first service node and a second service node;
allocating a service processing resource and binding the link address of the first service node and the second service node and establishing the service link; and
sending a link handover indication message to instruct the first service node and the second service node to hand over link connections with a first service processing unit.

5. The method of claim 4, wherein the method further comprises:
receiving link handover completion message from the first service node and the second service node; and
sending a response message to a first control unit, wherein the first control unit sends a service release link message to the first service processing unit, wherein the first service processing unit releases link connections with the first service node and the second service node in response to the release link message.

6. A method for service link handover, comprising:
applying for a service processing resource of a second service processing unit;
sending a service link establishment message which carries link address information of a first service node and a second service node to the second service processing unit, wherein the second service processing unit allocates a service processing resource and binds the link address of the first service node and the second service node and establishes the service link; and
sending a link handover indication message to instruct the first service node and the second service node to hand over link connections with a first service processing unit to the second service processing unit.

7. The method of claim 6, wherein the method further comprises: receiving a response message from the second service processing unit before sending the link handover indication message to the second service processing unit.

8. The method of claim 6, wherein the method further comprises:
receiving link handover completion message from the first service node and the second service node; and
sending a release link message to the first service processing unit, wherein the first service processing unit releases link with the first service node and the second service node in response to the release link message.

9. A method for service link handover, comprising:
receiving an application for a service processing resource and a service link establishment message which carries link address information of a first service node and a second service node;
allocating the service processing resource and binding the link address of the first service node and the second service node and establishing the service link; and
sending a link handover indication message to instruct the first service node and the second service node to hand over link connection with a first service processing unit to the second service processing unit.

10. The method of claim 9, wherein the method further comprises:
receiving link handover completion message from the first service node and the second service node; and
sending a release link message to the first service processing unit, wherein the first service processing unit releases the link with the first service node and the second service node in response to the release link message.

11. A system for service link handover, comprising:
a control unit, a second service processing unit, a first service node and a second service node, wherein,
the control unit is adapted to:
apply for a service processing resource of the second service processing unit; and
send a link establishment message which carries address information of the first service node and the second service node to the second service processing unit;
the second service processing unit is adapted to:
allocate the service processing resource in response to the application;
receive the link establishment message;
bind the address of the first service node and the second service node; and
establish link with the first service node and the second service node;
the first service node and the second service node are adapted to hand over link connections with a first service processing unit to the second service processing and control unit.

12. The system of claim 11, further comprising a releasing unit and the first service processing unit, wherein,
the releasing unit is adapted to send a release link message when the first service node and the second service node complete the link handover; and
the first service processing unit is adapted to release link with the first service node and the second service node in response to the release link message.

13. The system of claim 11, wherein the first service node and the second service node are adapted to hand over link connections with a first service processing unit to the second service processing and control unit when a link handover indication message is received from the control unit or the second service processing unit.

14. A system for service link handover, comprising:
a first control unit, a second service processing and control unit, a first service node and a second service node, wherein,
the first control unit is adapted to send a link establishment message which carries address information of a first service node and a second service node to the second service processing and control unit;
the second service processing and control unit is adapted to:
receive the link establishment message;
allocate a service processing resource:
bind the link address of the first service node and the second service node; and
establish link with the first service node and the second service node;
the first service node and the second service node are adapted to hand over link connections with a first service processing unit to the second service processing and control unit.

15. The system of claim 14, further comprising a releasing unit and the first service processing unit, wherein,
the releasing unit is adapted to send a release link message when the first service node and the second service node complete the link handover; and
the first service processing unit is adapted to release link with the first service node and the second service node in response to the release link message.

16. The system of claim 14, wherein the first service node and the second service node are adapted to hand over link connections with a first service processing unit to the second service processing and control unit when a link handover indication message is received from the first control unit or the second service processing and control unit.
